(19) United States
(12) Patent Application Publication
(10) Pub. No.: US 2022/0413982 A1
(43) Pub. Date: Dec. 29, 2022

(54) EVENT AND INCIDENT TIMELINES

(71) Applicant: Hewlett-Packard Development Company, L.P., Spring, TX (US)

(72) Inventors: Gaurav Roy, Spring, TX (US); Lorri L. Jefferson, Spring, TX (US); Robert Ray, Orlando, FL (US)

(73) Assignee: Hewlett-Packard Development Company, L.P., Spring, TX (US)

(21) Appl. No.: 17/770,654

(22) PCT Filed: Nov. 19, 2019
(86) PCT No.: PCT/US2019/062304

§ 371 Date: Apr. 21, 2022

(51) Int. Cl. G06F 11/30

(52) U.S. Cl. CPC G06F 11/3072; G06F 2201/835

(57) ABSTRACT

In some examples, a non-transitory computer-readable medium stores machine-readable instructions, which, when executed by a processor, cause the processor to: identify an event of a computing device from operational data of the computing device; evaluate the event to determine if the event is a non-routine event; and store the event to a timeline if the event is a non-routine event, where the timeline includes an incident of the computing device.

### BACKGROUND

Operational data of a computing device provides useful information in analyzing and diagnosing possible causes of incidents that occur on the computing device. The operational data of the computing device may contain event data (e.g., data about hardware; applications; security components; and their daily operations). The operational data may also contain incident data (e.g., data about a degradation in performance; irregular operations; a return to regular operations).

### BRIEF DESCRIPTION OF THE DRAWINGS

Various examples will be described below referring to the following figures:

FIG. 1 depicts a schematic diagram of a system, in accordance with various examples;

FIG. 2 depicts a schematic diagram of a system, in accordance with various examples;

FIG. 3 depicts a flow diagram of an illustrative method to produce an event and incident timeline, in accordance with various examples;

FIG. 4 depicts a lookup table illustrative of relationships utilized in determining whether an event belongs on an event and incident timeline, in accordance with various examples;

FIG. 5 depicts a flow diagram of an illustrative method to determine a priority of an event, in accordance with various examples;

FIG. 6 depicts an illustrative event and incident timeline, in accordance with various examples; and

FIG. 7 depicts a schematic diagram of a system, in accordance with various examples.

### DETAILED DESCRIPTION

As explained above, operational data (e.g., event data, incident data) of a computing device (e.g., laptop, notebook, tablet, smartphone, mobile device, or some other electronic device with an ability to capture data about operations of the device) provides information that is useful in analyzing and diagnosing possible causes of incidents that occur on the computing device. As also explained, event data includes a wide range of information about the computing device and its operations, such as data about hardware, applications, security components, and their daily operations. In one example, the installation of a new peripheral device might generate event data about hardware operations (e.g., new device installed), event data about application operations (e.g., new device driver installed), and event data about security operations (e.g., new device access rights). As mentioned above, the operational data may also contain incident data. An incident is an output of analysis performed on an event or a combination of events. The incident indicates a non-routine change or aberration in functionality of the computing device from a regular state to an irregular state (e.g., a degradation of performance, irregular operations) or from an irregular state to a regular state (e.g., a return to regular operations). For example, event data about battery performance might include statistics on the hour-by-hour operations of the battery and information on what additional hardware components (e.g., mouse, keyboard, graphics processing unit (GPU), central processing unit (CPU)) were utilized during the hour-by-hour operations. After analysis of the information, a computing device may generate an incident about battery degradation or irregular battery operations.

Sorting through the operational data to determine which events are non-routine and may be associated with an incident may be difficult due to the hundreds or thousands of events that occur daily on the computing device. The duration of the timeline may compound the difficulty. For example, if an incident is caused by a cumulative effect of events over a period of days, weeks, or months, then the hundreds or thousands of events are multiplied by the number of days of history that may be examined in a search for events associated with the incident.

This disclosure describes various examples of the creation of an event and incident timeline from filtered operational data. The operational data is filtered to remove event data that is noise (e.g., corrupt, incomplete, or redundant data) or is a usual event. Whether an event is noise or is usual is determined by a parameter or multiple parameters of the filtering. If an event of the event data is not noise or a usual event, the event may be labeled non-routine and stored to an event and incident timeline. To determine if the event is non-routine, the event may be filtered once or multiple times. The number of filters utilized may depend on factors such as a class of events with which the event is associated, an incident of the computing device that occurs during the time period covered by the timeline and that may relate to the event, other events of the computing device, or a result of a previous filtering process. The filter associated with a class of events may perform one round or multiple rounds of filtering on the event. In one example in accordance with the present disclosure, a non-transitory computer-readable medium is provided. The non-transitory computer-readable medium stores machine-readable instructions, which, when executed by a processor, cause the processor to: identify an event of a computing device from operational data of the computing device; evaluate the event to determine if the event is a non-routine event; and store the event to a timeline if the event is a non-routine event, where the timeline includes an incident of the computing device.

In another example in accordance with the present disclosure, a system is provided. The system comprises: a network interface; a storage device comprising machine-readable instructions; and a processor coupled to the network interface, the processor to access the storage device. Execution of the machine-readable instructions causes the processor to: collect operational data of a computing device communicatively coupled to the system via the network interface; categorize the operational data as an event; classify the event into a class of events; determine a pattern engine for evaluating the class of events; evaluate the event utilizing the pattern engine to determine if the event is a non-routine event; and store the event to a timeline if the event is a non-routine event, where the timeline includes an incident of the computing device.

In yet another example in accordance with the present disclosure, a method is provided. The method comprises collecting operational data of a computing device; identifying an event in the operational data; classifying the event into a class of events; identifying a machine learning technique for filtering noise within the class of events; utilizing the machine learning technique to determine if the event is noise; and storing the event to a timeline if the event is not noise, where the timeline includes an incident of the computing device.

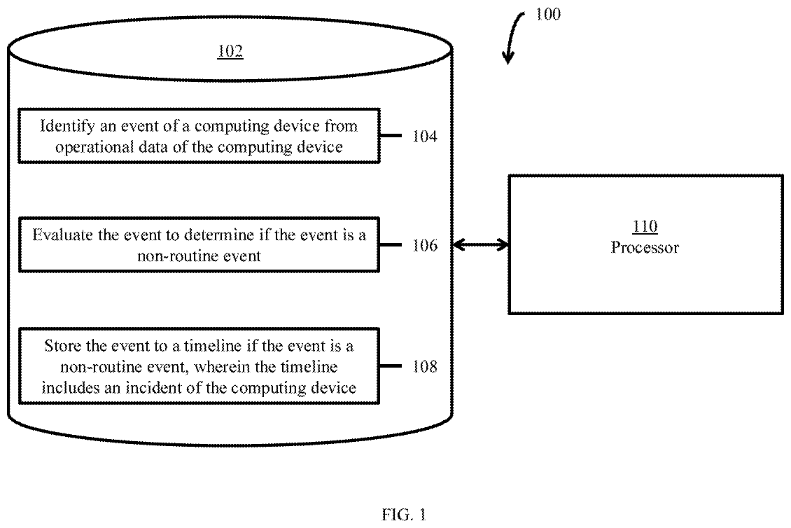

FIG. 1 depicts a schematic diagram of a system 100, in accordance with various examples. The system 100 comprises a computer-readable medium 102 and a processor 110 coupled to the computer-readable medium 102. The system 100 may be a computing device (e.g., a laptop, a notebook, a tablet, a smartphone, a mobile device, or some other electronic device with an ability to capture data about operations of the device) or a network of computing devices (e.g., local area network (LAN), wide area network (WAN), virtual private network (VPN), client/server network, Internet (e.g., cloud), or any other suitable system for sharing processing and memory resources). The computer-readable medium 102 may be a storage device such as a hard drive, solid state drive (SSD), flash memory, random access memory (RAM), or other suitable memory, for example. The computer-readable medium 102 may be local to a computing device or may be a remotely-managed storage device (e.g., enterprise cloud, public cloud, data center, server, or some other suitable storage device). The processor 110 may be a microprocessor, a microcomputer, a microcontroller, or another suitable embedded processor or embedded controller, for example. The processor 110 may be local to the computing device comprising the computer-readable medium 102 or may be on a remotely managed computing device (e.g., server, central server, edge server, or some other suitable computing device). The computer-readable medium 102 may store machine-readable instructions, which, when executed, cause the processor 110 to perform some or all of the actions attributed herein to the system 100.

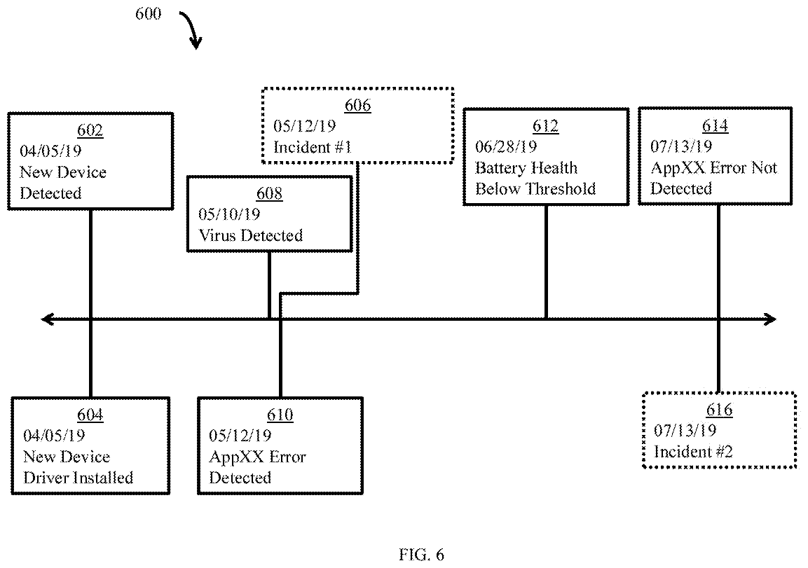

In some examples, the computer-readable medium 102 may store machine-readable instructions 104, 106, 108. The machine-readable instructions 104, 106, 108 may be machine-readable instructions for execution by the processor 110. The machine-readable instructions 104, 106, 108 may cause the processor to evaluate an event to determine if the event should be stored on an event and incident timeline. (See discussion with respect to FIG. 6 for an example of an event and incident timeline.) Execution of instruction 104 may cause the processor 110 to identify an event of a computing device from operational data of the computing device. The operational data may be stored on the computer-readable medium 102 or may be stored on a remotely-managed storage device (e.g., enterprise cloud, public cloud, data center, server, or some other suitable storage device). Execution of instruction 106 may cause the processor 110 to evaluate the event to determine if the event is a non-routine event. Execution of instruction 108 may cause the processor 110 to store the event to a timeline if the event is a non-routine event. The timeline may comprise a data structure (e.g., an object that stores and cross-references data, such as a lookup table or database) which, when displayed, depicts a passage of time and at what time an event occurred during the passage of time. (See discussion below with respect to FIG. 6 for an example of a timeline.) The timeline may be displayed by being published to a peripheral device (e.g., presented on a web page on a display, presented in a user interface on a display, printed out). As explained below, in addition to non-routine events, the timeline also may include an incident that may relate to the non-routine events and may indicate at what time the incident occurred.

Event data may be collected by a processor (e.g., processor 110) in real-time, daily, at scheduled increments, or on demand from the system 100. Incidents may not occur on a scheduled basis but rather in response to an event or a combination of events. An incident may present in operational data once the condition (e.g., a return to regular operations, a degradation of performance, or operations outside of defined parameters) for the incident is met.

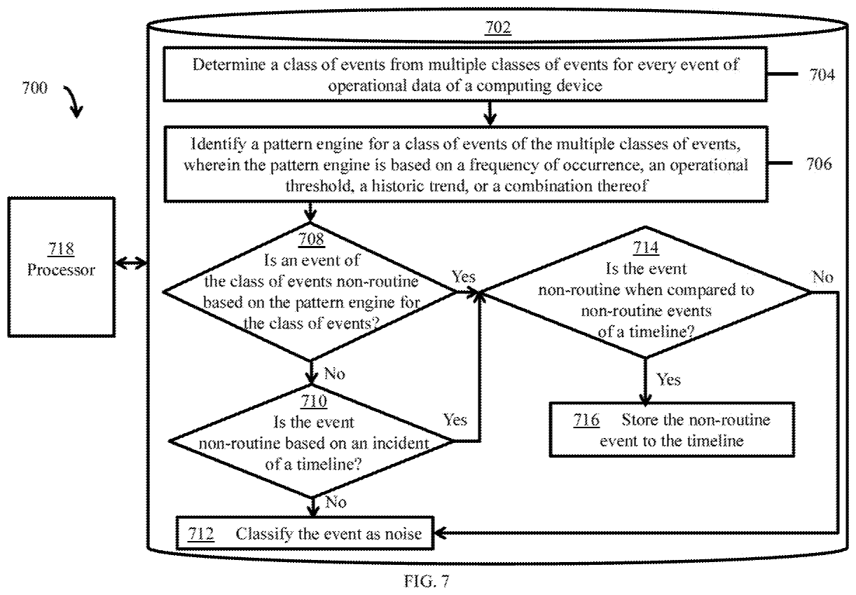

The processor 110 may evaluate an event to determine that the event is not noise and is not a usual event. If the event is not noise or a usual event, then the processor 110 may label the event non-routine and store it to a timeline. As discussed above, the processor 110 may filter the event once or multiple times during the evaluation. A filter may have a single or multiple parameters and may perform one round or multiple rounds of filtering on the event. In some examples, each round of filtering may be considered a level of filtering. In some examples, because of parameters established by a second filter, an event may be considered non-routine despite a first filter indicating the event is noise or a usual event. For example, a first filter may determine that an event about battery performance indicates the battery is operating within parameters, but a second filter may determine that operating within parameters is not noise or a usual event because previous events about battery performance indicate the battery was not operating within parameters. In some examples, an event may be considered non-routine after a first filter but then be classified as noise by a second filter. For example, an event about battery performance may indicate a battery is not operating within parameters, and a first filter may determine the event is non-routine. However, a second filter may classify the event as noise after determining the event is redundant to a non-routine event that is stored on a timeline and indicates the battery is not operating within parameters. (See below with respect to FIG. 7 for an example of a method utilizing multiple filters.)

In various examples, the time period of the non-routine event stored to the timeline may be increased to include the timing of the noisy event. The time period indicates the duration of the non-routine event. For example, the time period of the non-routine event may be expanded from one day to two days. Expanding the duration of the non-routine event, but not storing the noisy event, prevents cluttering the timeline. In some instances, selecting the non-routine event stored to the timeline (e.g., by touching the non-routine event using a touch-sensitive display) may provide a list of any noisy events related to the non-routine event. For example, selecting an event on the timeline presented on a web interface may enable a drop down menu of related noisy events to appear.

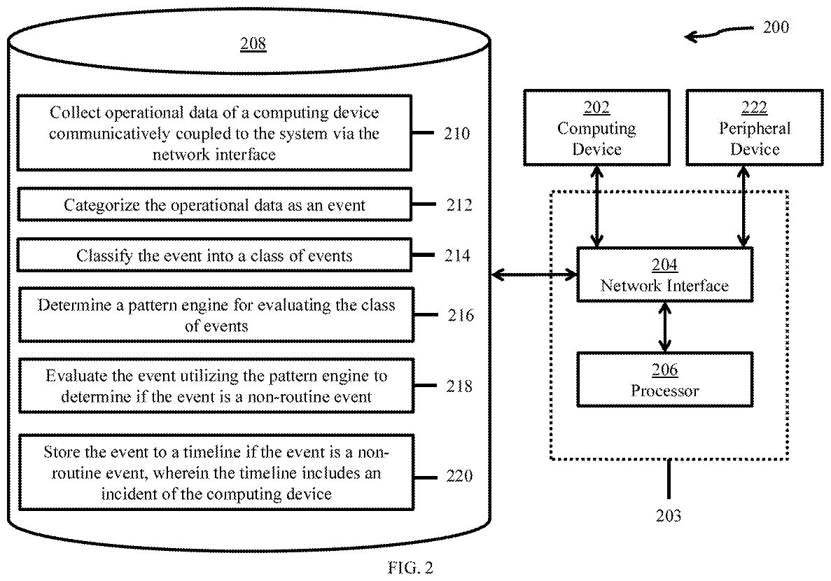

FIG. 2 depicts a schematic diagram of a system 200, in accordance with various examples. The system 200 comprises a computing device 202, a processing device 203, a storage device 208, and a peripheral device 222. The processing device 203 comprises a network interface 204 and a processor 206. The processing device 203 may be a remotely-managed computing device (e.g., server, central server, edge server, or some other suitable computing device) separate from, but communicatively coupled via the network interface 204 to, the storage device 208, the computing device 202, and the peripheral device 222. The processor 206 may comprise a microprocessor, a microcomputer, a microcontroller, or some other suitable processor or controller. The computing device 202 may be a laptop, notebook, tablet, smartphone, mobile device, or some other electronic device with an ability to capture data about operations of the device. The computing device 202 may be remote to, but communicatively coupled to, the storage device 208 via the network interface 204. The storage device 208 may comprise a hard drive, a solid state drive (SSD), flash memory, random-access memory (RAM), or some other suitable storage device. The storage device 208 may be a remotely managed storage device such as an enterprise cloud, a public cloud, a data center, a server, a database, or some other suitable storage device. The peripheral device 222 may be a display, a printer, or other suitable device for presenting information. The storage device 208 may include machine-readable instructions, which, when executed, cause the processor 206 to perform some or all of the actions attributed herein to the system 200.

In some examples, the storage device 208 may store machine-readable instructions 210, 212, 214, 216, 218, 220. The machine-readable instructions 210, 212, 214, 216, 218, 220 may cause the processor to evaluate an event to determine if the event should be stored on an event and incident timeline. (See discussion with respect to FIG. 6 for an example of an event and incident timeline.) Execution of the machine-readable instruction 210 may cause the processor 206 to collect operational data (e.g., event data, incident data) of the computing device 202. The operational data may be stored on the storage device 208 or a remotely managed storage device such as an enterprise cloud, a public cloud, a data center, a server, a database, or some other suitable storage device communicatively coupled to the system 200 via the network interface 204. Event data may be collected in real-time, daily, at scheduled increments, or on demand by the system 200. Incidents may not occur on a scheduled basis but rather in response to an event or a combination of events. An incident may present in operational data once the condition (e.g., a return to regular operations, a degradation of performance, or operations outside of defined parameters) for the incident is met.

Execution of the machine-readable instruction 212 may cause the processor 206 to categorize the operational data as an event. Execution of the machine-readable instruction 214 may cause the processor 206 to classify the event into a class of events. Execution of the machine-readable instruction 216 may cause the processor 206 to determine a pattern engine for evaluating the class of events. The pattern engine may be machine-readable instructions (e.g., computer-executable code) implementing a machine learning technique for filtering event data. The filtering may be a function of past data sets. From the past data sets, the pattern engine may establish a parameter or multiple parameters for a class of events to satisfy before an event of the class of events may be classified as non-routine. In some examples, the pattern engine may learn from new data sets and adjust the parameter or multiple parameters.

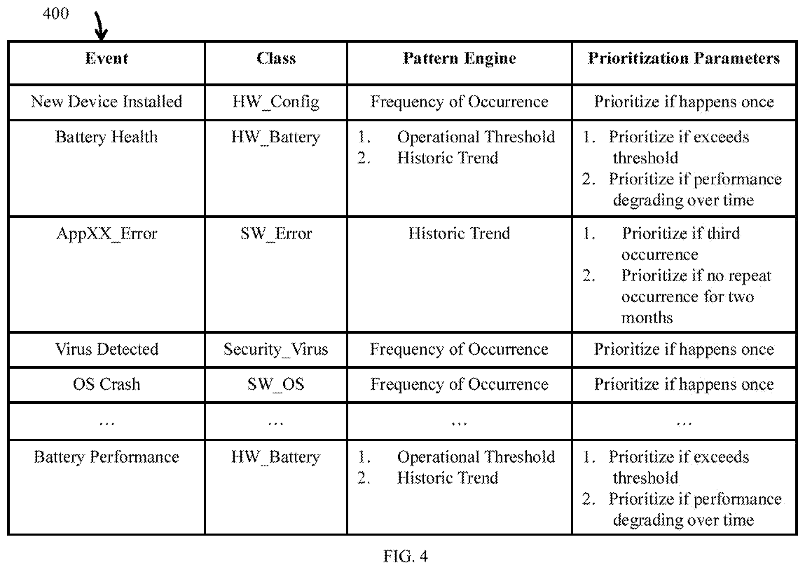

Execution of the machine-readable instruction 218 may cause the processor 206 to evaluate the event utilizing the pattern engine to determine if the event is a non-routine event. (See discussion below with respect to FIG. 4 for an example.) Execution of the machine-readable instruction 220 may cause the processor 206 to store the event to a timeline if the event is a non-routine event. The timeline also may include an incident that occurred during the time period and may relate to the non-routine events. Presenting the timeline with non-routine events and incidents may allow a user to diagnose root causes of the incidents. (See discussion below with respect to FIG. 6 for an example.)

In some examples, execution of the machine-readable instruction 212 may cause the processor 206 to determine that the operational data is an event after assimilating and cleaning the operational data. Assimilating and cleaning the operational data may include removing improper values (e.g., data outside actual possible parameters of a component) and partial data (e.g., errors in data collection). The assimilated and cleaned operational data may then be searched for an identifier that indicates an event. In some examples, the identifier may include an event type, a timestamp of the event, and a pseudorandom number.

In some examples, execution of the machine-readable instruction 214 may cause the processor 206 to classify the event into a class of events utilizing a lookup table. (See discussion below with respect to FIG. 4 for an example.) There may be multiple classes of events. An event may belong to one class of events of the multiple classes of events. A class of events is a set of related events. The related events may share a single attribute or multiple attributes. In various examples, the class of events may be categorized broadly (e.g., hardware, machine-readable instructions, security). A class of events may be subcategorized (e.g., hardware component, machine-readable instructions, malware) once or multiple times. In some examples, a set of related events may include one type of event or multiple types of events. (See discussion below with regard to FIG. 4 for an example.)

In some examples, execution of the machine-readable instruction 216 may cause the processor 206 to determine a pattern engine for evaluating the class of events utilizing a lookup table. (See discussion below with respect to FIG. 4 for an example.) In some examples, execution of the machine-readable instruction 218 may cause the processor 206 to utilize a lookup table to establish a priority used by the pattern engine for evaluating the event. The priority is a parameter or multiple parameters to satisfy before the event may be classified as non-routine. (See discussion below with respect to FIG. 4 for an example.)

In various examples, a pattern engine may be based on a frequency of occurrence. For example, for one class of events, any occurrence of an event may establish the priority of the event as sufficient to label the event as non-routine (e.g., a single event indicating an incident). For another class of events, an event should occur multiple times within a fixed time window before the priority of the event is established and the event is labeled as non-routine (e.g., an event indicating a degradation in operations of a component is continuing). (See discussion below with regard to FIG. 4 for an example.)

In some examples, a pattern engine may be based on an operational threshold. The operational threshold may be a single parameter threshold or a multi-parameter threshold. For example, for one class of events, if an event fails to satisfy a single threshold, then the parameter to establish a priority of the event as sufficient to label the event non-routine may be met. For another class of events, an event should fail in order to satisfy a parameter for a first threshold as well as a parameter for a second threshold before a priority of the event is established and the event is labeled as non-routine (e.g., an event should fail in order to satisfy a first threshold under a first condition as well as fail to satisfy a second threshold under a second condition). For yet another class, an event should fail in order to satisfy a single threshold multiple times before a priority of the event is established and the event is labeled as non-routine (e.g., to ensure an event does not contain corrupt, incomplete, or inaccurate data). (See discussion below with regard to FIG. 4 for an example.)

In various examples, a pattern engine may be based on a historic trend. The historic trend may indicate whether an event has occurred in the past, has not occurred in the past, or has not occurred within a specific time period. The historic trend may indicate whether an event occurred or did not occur during multiple time periods. For example, for one class of events, if an event has happened multiple times in the past, then the parameter to establish a priority of the event and label the event as non-routine may not be met (e.g., the event may be classified as noise). In another class of events, if an event has never happened in the past, then the parameter to establish a priority of the event and label the event as non-routine may be met. In yet another class of events, if an event does not occur during a specific time period, then the parameter to establish a priority of the event and label the event as non-routine may be met (e.g., if an event has not occurred during a previous two-month time period, then the non-occurrence of the event may indicate a recovery incident (e.g., recovery from a past incident)). (See discussion below with regard to FIG. 4 for an example.)

Turning ahead for a moment to FIG. 7, a system 700 is depicted comprising a computer-readable medium 702 and a processor 718 coupled to the computer-readable medium 702. The system 700 may be the system 100, 200, for example. The computer-readable medium 702 may be the computer-readable medium 102 or the storage device 208, for example. The processor 718 may be the processor 110, 206, for example.

In some examples, the computer-readable medium 702 may comprise machine-readable instructions 704, 706, 708, 710, 712, 714, 716. The machine-readable instructions 704, 706, 708, 710, 712, 714, 716 may be machine-readable instructions for execution by the processor 718. Execution of machine-readable instruction 704 may cause the processor 718 to determine a class of events from multiple classes of events for every event of operational data of a computing device (e.g., computing device 202). In some examples, the processor 718 may utilize a lookup table to determine a class of events. (See discussion below with regard to FIG. 4 for an example.) Execution of machine-readable instruction 706 may cause the processor 718 to identify a pattern engine for a class of events of the multiple classes of events, where the pattern engine is based on a frequency of occurrence, an operational threshold, a historic trend, or a combination thereof. In some examples, the processor 718 may utilize a lookup table to identify a pattern engine. (See discussion below with regard to FIG. 4 for an example.) Execution of machine-readable instruction 708 may cause the processor 718 to determine if an event of the class of events is non-routine based on the pattern engine for the class of events, as explained above in the discussion with regard to FIG. 2. Execution of machine-readable instruction 710 may cause the processor 718 to determine if the event is non-routine based on an incident of a timeline. For example, the processor 718 may compare the event to the event or combination of events analyzed to generate the incident. Execution of machine-readable instruction 712 may cause the processor 718 to classify the event as noise. Execution of machine-readable instruction 714 may cause the processor 718 to determine if the event is non-routine when compared to events of the timeline. Execution of machine-readable instruction 716 may cause the processor 718 to store the non-routine event to the timeline. (See discussion below with respect to FIG. 6 for an example timeline.) The processor 718 may repeat the method 700 starting at machine-readable instruction 706 for every event in the class of events.

In some examples, if the processor 718 determines a “yes” response to instruction 708 (e.g., a first filter indicates the event is non-routine), then the processor 718 may execute machine-readable instruction 714 (e.g., utilize a second filter). If the processor 718 determines a “yes” response to machine-readable instruction 714 (e.g., the event is non-routine compared to events of a timeline), then the processor, 718 may execute machine-readable instruction 716 and store the non-routine event to the timeline. If the processor 718 determines a “no” response to machine-readable instruction 714 (e.g., a second filter indicates the event is not a non-routine event), then the processor 718 may execute machine-readable instruction 712 and classify the event as noise. If the processor 718 determines a “no” response to machine-readable instruction 708 (e.g., the event is not a non-routine event based on the pattern engine for the class of events), then the processor 718 may execute machine-readable instruction 710 (e.g., utilize a second filter). If the processor 718 determines a “yes” response to machine-readable instruction 710 (e.g., the event is non-routine based on an incident of a timeline), then the processor 718 may execute machine-readable instruction 714 (e.g., utilize a third filter). If the processor 718 determines a “no” response to machine-readable instruction 710 (e.g., the event is not non-routine based on an incident of a timeline), then the processor 718 may execute machine-readable instruction 712 and classify the event as noise.

In some examples, the processor 718 may use a single filter. For example, if the processor 718 determines a “yes” response to machine-readable instruction 708, then the processor 718 may skip machine-readable instruction 714 and execute machine-readable instruction 716 (e.g., store the non-routine event to a timeline). In another example, if the processor 718 determines a “no” response to machine-readable instruction 708, then the processor 718 may skip machine-readable instruction 710 and execute machine-readable instruction 712 (e.g., classify the event as noise). In some examples, the processor 718 may decide to utilize a second filter, but not a third filter. For example, if the processor 718 determines a “yes” response to machine-readable instruction 710, then the processor 718 may skip machine-readable instruction 714 and execute machine-readable instruction 716 (e.g., store the non-routine event to the timeline).

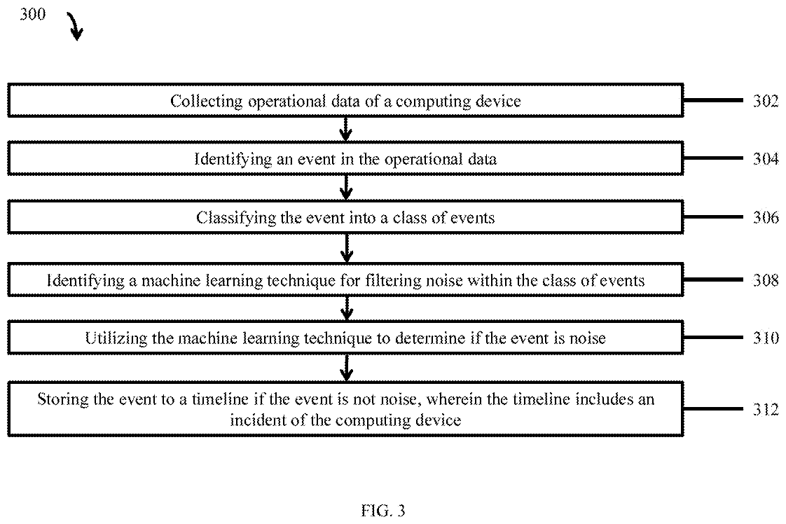

Turning now to FIG. 3, an illustrative method 300 produces an event and incident timeline, in accordance with various examples. The method 300 includes collecting operational data of a computing device (302). In addition, the method 300 includes identifying an event in the operational data (304). The method 300 also includes classifying the event into a class of events (306). Additionally, the method 300 includes identifying a machine learning technique (e.g., pattern engine) for filtering noise within the class of events (308). The method 300 includes utilizing the machine learning technique to determine if the event is noise (310). The method 300 also includes storing the event to a timeline if the event is not noise (312). The timeline may also include an incident of the computing device that occurred during the time period and may be related to the non-routine event. Presenting the timeline with non-routine events and incidents may allow a user to diagnose root causes of the incidents.

In various examples, the method 300 may be performed by the processor 110, 206, 718 of the system 100, 200, 700. For example, machine-readable instruction 302 may be performed by the processor 110, 206, 718 via a network interface (e.g., network interface 204). Collection of the operational data may occur in real-time, daily, at scheduled increments, or on demand by the system 100, 200, 700. In some examples, machine-readable instruction 304 may be performed by the processor 110, 206, 718 by assimilating and cleaning the operational data and then searching the assimilated and cleaned operational data for an identifier that indicates an event. In some examples, machine-readable instruction 306 may be performed by the processor 110, 206, 718 by utilizing a lookup table. (See discussion below with respect to FIG. 4 for an example.) In some examples, the processor 110, 206, 718 may classify every event in the operational data into a class of events from multiple classes of events before identifying a machine learning technique for filtering noise within a class of events (308). In various examples, the processor 110, 206, 718 may utilize a lookup table for identifying a machine learning technique for filtering noise within the class of events. (See discussion below with respect to FIG. 4 for an example.) In some examples, utilizing the machine learning technique to determine if the event is noise (310) may occur by the processor 110, 206, 718 examining a priority associated with the machine learning technique. In various examples, the priority may be stored in a lookup table utilized by the processor 110, 206, 718. (See discussion below with respect to FIG. 4 for an example.) In some examples, the processor 110, 206, 718 may also compare the event to an event or incident stored on a timeline before determining if the event is noise. Storing the event to a timeline if the event is not noise may be performed by the processor 110, 206, 718 storing the event to a data structure which, when displayed, depicts a passage of time and at what time an event or incident occurred during the passage of time. The timeline may be displayed by being published to a peripheral device (e.g., peripheral device 222), for example, in a form of a web page or user interface shown on a display or a printer that prints the timeline.

FIG. 4 depicts a lookup table 400 illustrative of relationships utilized in determining if an event belongs on an event and incident timeline, in accordance with various examples. The lookup table 400 may be part of a data structure stored on a storage device (e.g., storage devices 102, 208, 702). The lookup table 400 demonstrates the relationship between events and classes of events. The lookup table 400 also demonstrates the relationship between the classes of events and pattern engines. Additionally, the lookup table 400 demonstrates the relationships between the pattern engines and prioritization parameters for the pattern engines to utilize based on an event or a class of events.

In some examples, the descriptors of the event column of the lookup table 400 may indicate a component type. For example, “AppXX” may denote an event associated with machine-readable instructions of an application named “AppXX;” and “OS” may associate to an operating system. Additional description may be provided. For example, for an application, an event may be further described by an error code of the application. The descriptors for the class of events may indicate a type of component—hardware (e.g., HW), machine-readable instructions (e.g., SW), or security. Additionally, a subclass may be indicated—configuration (e.g., Config), operating system (e.g., OS), virus, battery, or error.

For example, in the lookup table 400, a “New Device Installed” event is classified to a “HW Config” class of events, which utilizes a “Frequency of Occurrence” pattern engine with a prioritization parameter of “Prioritize if happens once.” A “Battery Health” event is a first event type classified to a “HW Battery” class of events, which utilizes an “Operational Threshold” pattern engine with a prioritization parameter of “Prioritize if exceeds threshold” and a “Historic Trend” pattern engine with a prioritization parameter of “Prioritize if performance degrading over time.” An “AppXX_Error” event is classified to a “SW Error” class of events, which utilizes a “Historic Trend” pattern engine with a first prioritization parameter of “Prioritize if third occurrence” and a second prioritization parameter of “Prioritize if no repeat occurrence for two months.” A “Virus Detected” error is classified to a “Security_Virus” class of events, which utilizes a “Frequency of Occurrence” pattern engine with a prioritization parameter of “Prioritize if happens once.” An “OS Crash” event is associated with a “SW OS” class of events, which utilizes a “Frequency of Occurrence” pattern engine with a prioritization parameter of “Prioritize if happens once.” A “Battery Performance” event is a second event type classified to a “HW_Battery” class of events, which utilizes an “Operational Threshold” pattern engine with a prioritization parameter of “Prioritize if exceeds threshold” and a “Historic Trend” pattern engine with a prioritization parameter of “Prioritize if performance degrading over time.”

In various examples, upon the processor 110, 206, 718 identifying a “New Device Installed” event of operational data of a computing device (e.g., 202), the processor 110, 206, 718 may utilize the lookup table 400 to determine that the event should be classified to the “HW_Config” class of events. In some examples, this determination may occur for every event of the operational data until all events of the operational data are classified into a class of events. Returning to the “New Device Installed” event, the processor 110, 206, 718 may utilize the lookup table 400 to evaluate the event with a pattern engine that filters the event based on a frequency of occurrence. The processor 110, 206, 718 may utilize the lookup table 400 to determine the “New Device Installed” event should be prioritized if the event happens once.

After the classification of an event into a class of events, the class of events may be associated with zero events, one event, or a plurality of events. The plurality of events may include multiple types of events. For example, in the lookup table 400, the class of events “HW_Battery” includes a first type of event “Battery Health” and a second type of event “Battery Performance.” In some examples, the first type of event may utilize a first pattern engine associated with the class of event and the second type of event may utilize a second pattern engine associated with the class event. For example, in the lookup table 400, a “Battery Health” event may utilize the “Operational Threshold” pattern engine with a prioritization parameter of “Prioritize if exceeds threshold,” and a “Battery Performance” event may utilize the “Historic Trend” pattern engine with a prioritization parameter of “Prioritize if performance degrading over time.”

In some examples, a class of events with multiple types of events and multiple pattern engines may apply every pattern engine to every type of event (e.g., every pattern engine filters the data such that the data may pass through a number of filters). For example, in the lookup table 400, a “Battery Health” event may utilize an “Operational Threshold” pattern engine with a prioritization parameter of “Prioritize if exceeds threshold” and a “Historic Trend” pattern engine with a prioritization parameter of “Prioritize if performance degrading over time.” A first filter utilizes the “Operational Threshold” pattern engine. If the “Battery Health” event satisfies the prioritization parameter for the “Operational Threshold” pattern engine, then a second filter utilizes the “Historic Trend” pattern engine. If the “Battery Health” event satisfies the prioritization parameter for the “Historic Trend” pattern engine, then the processor 110, 206, 718 determines the “Battery Health” event is not noise and stores the “Battery Health” event to a timeline including an incident of the computing device (e.g., 202). If the “Battery Health” event fails to satisfy the prioritization parameter for the first filter or the prioritization parameter for the second filter, then the processor 110, 206, 718 determines that the “Battery Health” event is noise.

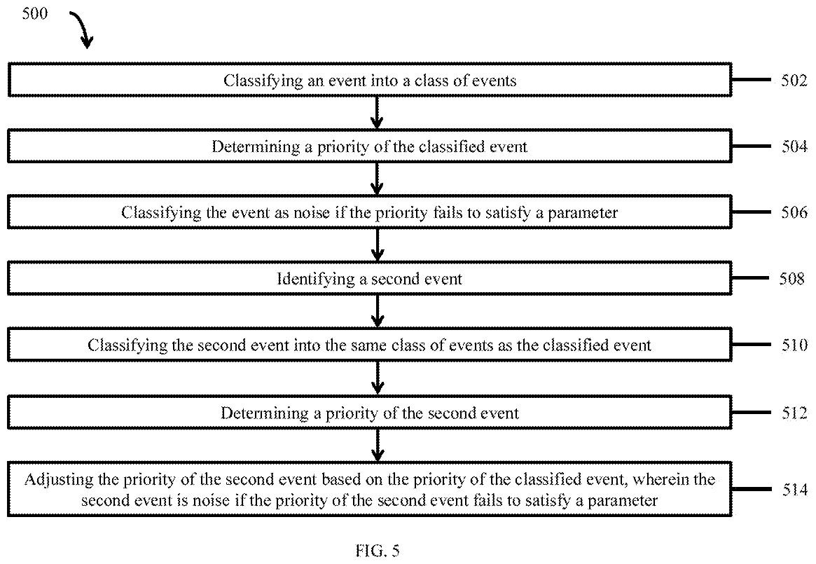

FIG. 5 depicts a flow diagram of an illustrative method 500 to determine a priority of an event, in accordance with various examples. The method 500 includes classifying an event into a class of events (502). In addition, the method 500 includes determining a priority of the classified event (504). The method 500 also includes classifying the event as noise if the priority fails to satisfy a parameter (506). Additionally, the method 500 includes identifying a second event (508). The method 500 includes classifying the second event into the same class of events as the classified event (510). The method 500 also includes determining a priority of the second event (512). In addition, the method 500 includes adjusting the priority of the second event based on the priority of the classified event. The second event is noise if the priority of the second event fails to satisfy a parameter (514).

In various examples, the method 500 may be performed by the processor 110, 206, 718 of the system 100, 200, 700. The processor 110, 206, 718 may classify an event into a class of events. In some examples, the processor 110, 206, 718 may utilize a lookup table (e.g., 400) to classify the event into a class of events. For example, utilizing lookup table 400, the processor 110, 206, 718 may identify an “AppXX_Error” event and classify it into a “SW Error” class of events. The processor 110, 206, 718 may then determine a priority of the classified event utilizing a lookup table (e.g., 400). For example, the processor 110, 206, 718 may determine the “AppXX_Error” event is prioritized if data of the “AppXX_Error” event exceeds a threshold. If the classified event fails to satisfy a prioritization parameter, then the processor 110, 206, 718 may determine that the classified event is noise. If the classified event satisfies the prioritization parameter, then the classified event is prioritized. After identifying a second event, the processor 110, 206, 718 may determine the second event also belongs to the same class of events as the classified event. For example, utilizing the lookup table 400, the processor 110, 206, 718 may identify a second event as an “AppXX_Error” error and classify the second event in the “SW Error” class of events. The processor 110, 206, 718 may determine that the second “AppXX_Error” event is prioritized because data of the “AppXX_Error” event exceeds a threshold. The processor 110, 206, 718 may then adjust the priority of the second event based on the priority of the first event. For example, the processor 110, 206, 718 may compare the priority of the classified event to the priority of the second event and determine that the second event is noise because the priority of the second event fails to satisfy a parameter. In some examples, the parameter may be that the priority of the second event does not equal the priority of the classified event. For example, if the classified event is prioritized and the second event is prioritized, then the second event is classified as noise. However, in another example, the parameter may be that the priority of the second event is not noise. For example, if the classified event is one type of event of the class of events and the second event is a second type of event of the class of events and both the first and second types are prioritized, then the processor 110, 206, 718 may store both the classified event and the second event to a timeline that includes an incident of a computing device (e.g., 202).

FIG. 6 depicts an illustrative event and incident timeline 600, in accordance with various examples. The timeline 600 includes events 602, 604, 608, 610, 612, 614. The timeline 600 also includes incidents 606, 616. The event 602 informs a user that a new device was detected on 04/05/19. The event 604 informs the user that a new device driver was installed on 04/05/19. The event 608 informs the user that a virus was detected on 05/10/19. The event 610 informs the user that an AppXX Error was detected on 05/12/19. The event 612 informs the user that a battery health of a computing device fell below a threshold on 06/28/19. The event 614 informs the user that an AppXX Error was not detected on 07/13/19. The incident 606 informs the user that there was a first incident on 05/12/19. The incident 616 informs the user that there was a second incident on 07/13/19.

The timeline 600 may be an example of a timeline created by the processor 110, 206, 718 of the system 100, 200, 700 utilizing the method of FIG. 3 or FIG. 5. The processor 110, 206, 718 may utilize a lookup table (e.g., 400) to determine if an event of operational data of a computing device (e.g., 202) is non-routine. For example, the processor 110, 206, 718 may store “New Device Detected” to the timeline 600 because the event satisfied a prioritization parameter that the event occurred once. The processor 110, 206, 718 may store “New Device Driver” to the timeline 600 because the event satisfied a prioritization parameter that the event occurred once. The processor 110, 206, 718 may also store “Virus Detected” to the timeline 600 because the event satisfied a prioritization parameter that the event occurred once. Additionally the processor 110, 206, 718 may also store “AppXX Error Detected” to the timeline 600 because the event satisfied a prioritization parameter that the event occurred once. The processor 110, 206, 718 may store “AppXX Error Not Detected” to the timeline 600 because the event satisfied a prioritization parameter that an “AppXX Error Detected” event had not occurred during the prior two month period (e.g., indicating a recovery incident). The processor 110, 206, 718 may store the “Battery Health Below Threshold” event to the timeline 600 because the event failed to satisfy a prioritization parameter that the event not fall below a threshold. The processor 110, 206, 718 may store the first and the second incident to the timeline 600 because they both occurred during the time period displayed.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the following discussion and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections. As used herein, including in the claims, the word “or” is used in an inclusive manner. For example, “A or B” means any of the following: “A” alone, “B” alone, or both “A” and “B.” In addition, when used herein including the claims, the word “generally” or “substantially” means within a range of plus or minus 10% of the stated value.

What is claimed is:

1. A non-transitory computer-readable medium storing machine-readable instructions, which, when executed by a processor, cause the processor to:
identify an event of a computing device from operational data of the computing device;
evaluate the event to determine if the event is a non-routine event; and
store the event to a timeline if the event is a non-routine event, wherein the timeline includes an incident of the computing device.

2. The computer-readable medium of claim 1, wherein execution of the machine-readable instructions causes the processor to determine if the event is non-routine utilizing a pattern engine.

3. The computer-readable medium of claim 2, wherein execution of the pattern engine causes the processor to determine if the event is non-routine based on a frequency of occurrence, an operational threshold, a historic trend, or a combination thereof.

4. The computer-readable medium of claim 2, wherein execution of the machine-readable instructions causes the processor to store the non-routine event to the timeline if the non-routine event is also non-routine in relation to other non-routine events stored to the timeline.

5. The computer-readable storage of medium 1, wherein execution of the machine-readable instructions causes the processor to classify an event as non-routine based on the incident of the computing device.

6. A system comprising:
a network interface;
a storage device comprising machine-readable instructions; and
a processor coupled to the network interface, the processor to access the storage device, wherein execution of the machine-readable instructions causes the processor to:
collect operational data of a computing device communicatively coupled to the system via the network interface;
categorize the operational data as an event;
classify the event into a class of events;
determine a pattern engine for evaluating the class of events;
evaluate the event utilizing the pattern engine to determine if the event is a non-routine event; and
store the event to a timeline if the event is a non-routine event, wherein the timeline includes an incident of the computing device.

7. The system of claim 6, wherein execution of the machine-readable instructions causes the processor to evaluate the event as a non-routine event based on the incident of the timeline.

8. The system of claim 6, wherein execution of the machine-readable instructions causes the processor to evaluate the event to determine if the event is non-routine utilizing the pattern engine used to filter the class of events.

9. The system of claim 8, wherein execution of the pattern engine causes the processor to evaluate the event as non-routine based on a frequency of occurrence, an operational threshold, a historic trend, or a combination thereof.

10. The system of claim 9, wherein execution of the pattern engine causes the processor to evaluate the non-routine event as noise after a second evaluation based on a second frequency of occurrence, a second operational threshold, a second historic trend, or a combination thereof.

11. A method comprising:
collecting operational data of a computing device;
identifying an event in the operational data;
classifying the event into a class of events;
identifying a machine learning technique for filtering noise within the class of events;
utilizing the machine learning technique to determine if the event is noise; and
storing the event to a timeline if the event is not noise, wherein the timeline includes an incident of the computing device.

12. The method of claim 11, wherein the machine learning technique comprises:
determining a priority of the classified event based on a frequency of occurrence, an operational threshold, a historic trend, or a combination thereof; and
classifying the event as noise if the priority fails to satisfy a parameter.

13. The method of claim 12, wherein the machine learning technique comprises:
identifying a second event in the operational data;
classifying the second event into the same class of events as the classified event;
determining a priority of the second event based on a frequency of occurrence, an operational threshold, a historic trend, or a combination thereof; and
adjusting the priority of the second event based on the priority of the classified event, wherein the second event is noise if the priority of the second event fails to satisfy a parameter.

14. The method of claim 11, wherein the timeline includes multiple incidents.

15. The method of claim 11, comprising publishing the timeline to a peripheral device.
